(19) United States
(12) Patent Application Publication
(10) Pub. No.: US 2019/0061545 A1
(43) Pub. Date: Feb. 28, 2019

(54) SYSTEMS AND METHODS FOR ELECTRIC VEHICLE CHARGING WITH AUTOMATED TRIP PLANNING INTEGRATION

(71) Applicant: Electric Motor Werks, Inc., San Carlos, CA (US)

(72) Inventors: DORIAN VARGAS-REIGHLEY, Palo Alto, CA (US); VALERY MIFTAKHOV, San Carlos, CA (US)

(73) Assignee: Electric Motor Werks, Inc., San Carlos, CA (US)

(21) Appl. No.: 15/691,759

(22) Filed: Aug. 31, 2017

(51) Int. Cl. B60L 11/18; G01C 21/34; G01C 21/36

(52) U.S. Cl. CPC B60L 11/1838; G01C 21/3469; G01C 21/343; B60L 2240/66; B60L 2240/60; B60L 2240/68; G01C 21/362

(57) ABSTRACT

Systems and methods for electric vehicle charging with automated trip planning integration. The inventive charging system sends requests to various available web services, such as mapping or route planning service, weather service and the like to obtain various data related to the planned trip. Such data may include trip distance, terrain information, vehicle information, traffic data, weather data as well as vehicle user driving behavior. All this information is used to calculate the amount of battery charge required to complete the trip. The system then automatically issues a charge command to electric vehicle supply equipment to charge the vehicle in accordance with the calculated battery charge amount.

### BACKGROUND OF THE INVENTION

### Field of the Invention

The disclosed embodiments relate in general to electric vehicle charging technology, and, more specifically, to systems and methods for electric vehicle charging with automated trip planning integration.

### Description of the Related Art

Irrational fear that an electric vehicle has insufficient battery charge to reach its destination and would thus strand the vehicle's occupants is called “range anxiety” and is considered to be one of the major barriers to large scale adoption of all-electric cars. Increased availability of electric vehicle charging stations, including peer-to-peer charging solutions as well as various range extending technologies, has alleviated range anxiety to a certain extent. However, the range anxiety problem still remains.

On the other hand, accurate trip planning can also be used for insuring that the electric vehicle has enough battery charge to get to its intended destination. Currently, however, there are no charging solutions on the market that would directly integrate accurate trip planning technology with electric vehicle charging stations and use the available trip planning data to determine the amount of charge that the vehicle needs. Users have to first use standard trip planning software or service and then manually ensure that the vehicle has enough charge. On the other hand, having an integrated solution would further help reduce the aforesaid range anxiety in electric vehicle users.

### SUMMARY OF THE INVENTION

The inventive methodology is directed to methods and systems that substantially obviate one or more of the above and other problems associated with conventional EV charging technology.

In accordance with one aspect of the embodiments described herein, there is provided a system for electric vehicle charging with automated trip planning integration comprising: an electric vehicle supply equipment for charging an electric vehicle battery from an electric power grid; and a control server communicatively coupled with the electric vehicle supply equipment via a data network and executing a software application and configured to: receive trip information from a user; obtain data associated with the trip information from a third party service; calculate a required charge level for the electric vehicle battery based on the received trip information and the obtained trip associated data; and issue a vehicle charge command to the electric vehicle supply equipment based on the calculated required electric vehicle battery charge level.

In one or more embodiments, the trip information comprises a trip destination.

In one or more embodiments, the trip information comprises a trip departure time.

In one or more embodiments, the trip information comprises information on at least one stop along the way.

In one or more embodiments, the obtained trip associated data comprises weather data.

In one or more embodiments, the weather data comprises temperature data.

In one or more embodiments, the weather data comprises wind data.

In one or more embodiments, the obtained trip associated data comprises traffic data.

In one or more embodiments, the traffic data comprises traffic speed data.

In one or more embodiments, the obtained trip associated data comprises day of the week data.

In one or more embodiments, the obtained trip associated data comprises vehicle data.

In one or more embodiments, the vehicle data comprises battery capacity data.

In one or more embodiments, the vehicle data comprises efficiency data.

In one or more embodiments, the vehicle data comprises aerodynamics data.

In one or more embodiments, the obtained trip associated data comprises driver data.

In one or more embodiments, the driver data comprises historical speed data.

In one or more embodiments, the driver data comprises historical braking data.

In one or more embodiments, the obtained trip associated data comprises distance data.

In one or more embodiments, the obtained trip associated data comprises route data.

In one or more embodiments, the obtained trip associated data comprises terrain data.

In accordance with another aspect of the embodiments described herein, there is provided a non-transitory computer-readable medium embodying a set of computer-executable instructions, which, when executed in connection with a system for electric vehicle charging with automated trip planning integration comprising an electric vehicle supply equipment for charging an electric vehicle battery from an electric power grid and a control server communicatively coupled with the electric vehicle supply equipment via a data network and executing a software application, causes the system to: receive trip information from a user; obtain data associated with the trip information from a third party service; calculate a required charge level for the electric vehicle battery based on the received trip information and the obtained trip associated data; and issue a vehicle charge command to the electric vehicle supply equipment based on the calculated required electric vehicle battery charge level.

In accordance with yet another aspect of the embodiments described herein, there is provided a method performed in connection with a system for electric vehicle charging with automated trip planning integration comprising: an electric vehicle supply equipment for charging an electric vehicle battery from an electric power grid and a control server communicatively coupled with the electric vehicle supply equipment via a data network and executing a software application, the method comprising: receiving trip information from a user; obtaining data associated with the trip information from a third party service; calculating a required charge level for the electric vehicle battery based on the received trip information and the obtained trip associated data; and issuing a vehicle charge command to the electric vehicle supply equipment based on the calculated required electric vehicle battery charge level.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of the system for electric vehicle charging with automated trip planning integration.

FIG. 2 illustrates an exemplary operating sequence of an embodiment of the system for electric vehicle charging with automated trip planning integration.

FIG. 3 illustrates an exemplary embodiment of the system for electric vehicle charging with automated trip planning integration, wherein the processing is performed on a mobile device of the user.

FIG. 4 is a block diagram that illustrates an embodiment of a computer/server system upon which an embodiment of the inventive technology may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

In accordance with one aspect of the embodiments described herein, there are provided systems and methods for electric vehicle charging with automated trip planning integration. In one embodiment, the inventive charging system sends requests to various available web services, such as mapping or route planning service, weather service and the like to obtain various data related to the planned trip. Such data may include trip distance, terrain information, traffic data, road condition data, vehicle information, weather data as well as vehicle user driving behavior. All this information is used to calculate the amount of battery charge required to complete the trip. The system then automatically issues a charge command to electric vehicle supply equipment to charge the vehicle in accordance with the calculated battery charge amount.

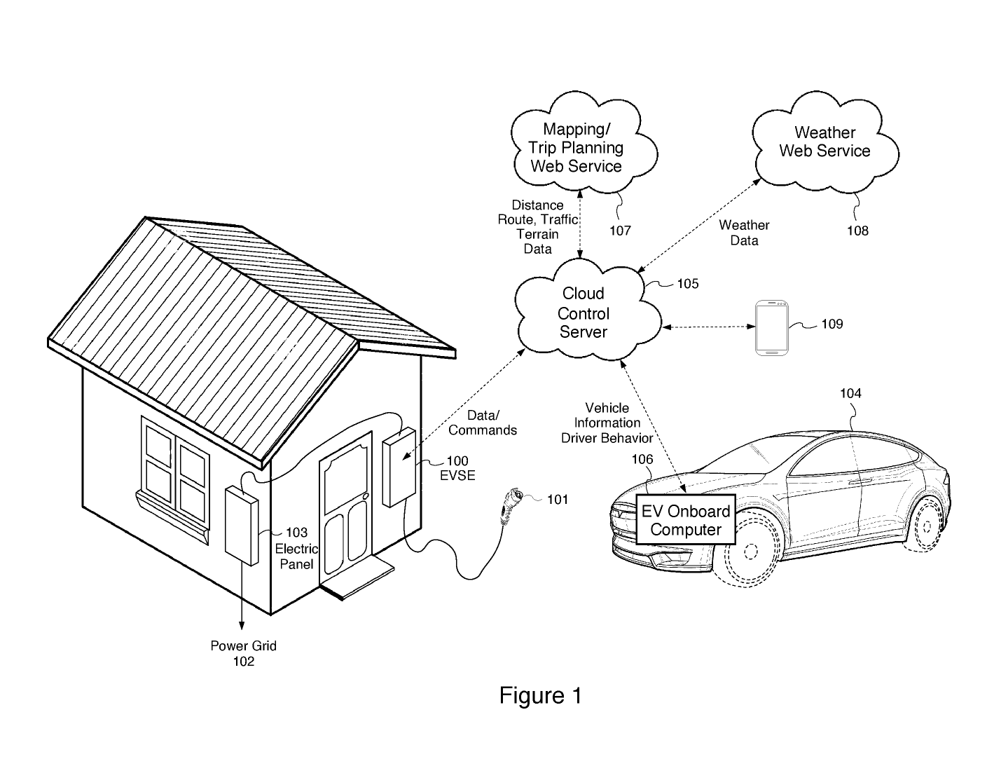

FIG. 1 illustrates an exemplary embodiment of the system for electric vehicle charging with automated trip planning integration. In one or more embodiments, the vehicle charging network shown in FIG. 1 comprises a cloud control server 105 for controlling multiple electric vehicle supply equipment (EVSE) a.k.a. “charging stations” 100 via a data network. The EVSE 100 is connected to electric power grid 102 via house's electric panel 103. In one or more embodiments, the EVSE 100 is electrically coupled to an electric vehicle 104 using a charge plug 101. The cloud control server 105 may send and/or receive data and send vehicle charging commands to the application programming interface of the EVSE 100 via a data network, such as Internet. In one embodiment, the cloud control server 105 controls the one or more EVSE 100 based on a trip planning application executing on the cloud control server 105.

In one or more embodiments, the trip planning application uses a variety of information related to the destination, vehicle, driver and environment to calculate the amount of charge that the electric vehicle would need to complete the planned trip. The aforesaid information may be obtained by the trip planning application executing on the cloud control server 105 from a variety of locations and/or services, such as web services 107 or 108, via a data network, such as Internet, as described in detail below.

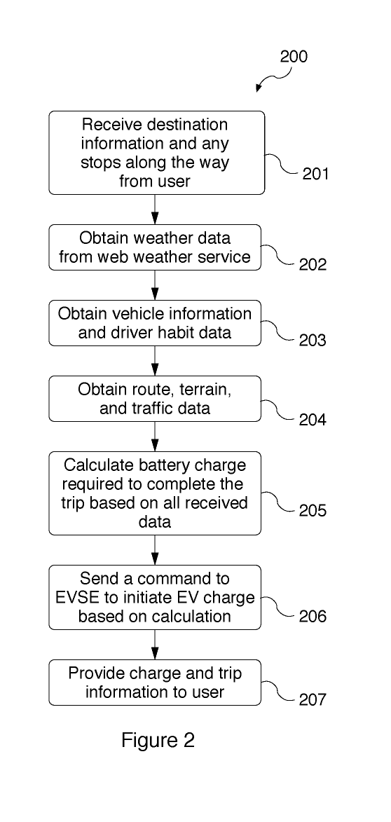

FIG. 2 illustrates an exemplary operating sequence 200 of an embodiment of the system for electric vehicle charging with automated trip planning integration. First, at step 201, user provides trip destination and departure time information into a mobile application executing on user's smartphone 109 or into an EV onboard computer 106 using user interface of the electric vehicle 104. The input information is then transmitted to the cloud control server 105.

At step 202, the cloud control server 105 issues a request to web weather service 108 for weather forecast data for one or more geographical locations along the trip route at specific times calculated based on the trip departure time specified by the user as well as route, speed limit and terrain parameters. The aforesaid request may be an HTTP protocol request. The aforesaid web weather service 108 responds with the requested weather forecast data back to the cloud control server 105. In one or more embodiments, the requested weather forecast data may include, without limitation, temperature, humidity, precipitation and/or wind data.

At step 203, the cloud control server 105 issues a request to an application programming interface of the electric vehicle onboard computer 106 for vehicle and driver habit data. The aforesaid request may be an HTTP protocol request. To this end, the electric vehicle 104 may be connected to the Internet using, for example, house WIFI connection. In one or more embodiments, the requested vehicle data may include, without limitation, the type of electric vehicle, the battery capacity of the electric vehicle, vehicle power consumption/efficiency data, vehicle body aerodynamics data, regenerative braking performance data, as well as any other type if data related to the electric vehicle. On the other hand, the driver habit data may include, without limitation, the historical speed data, the historical breaking data, the historical acceleration data, as well as any other data related to the driver of the vehicle. The aforesaid EV onboard computer 106 responds with the requested data back to the cloud control server 105.

At step 204, the cloud control server 105 issues a request to mapping/trip planning web service 107 for distance, route, traffic, road condition and terrain data. The aforesaid request may be an HTTP protocol request. In one embodiment, the mapping/trip planning web service 107 is Google Maps service, well known to persons of ordinary skill in the art. The responsive data sent by the mapping/trip planning web service 107 back to the cloud control server 105 may include the distance, route, traffic, road condition and terrain data.

At step 205, the application executing on the cloud control server 105 uses all the above-described received weather, time of the day and day of the week, vehicle, driver, distance, route, traffic, road condition and terrain data to calculate the amount of battery charge necessary for the electric vehicle 104 to complete the trip to the destination. For example, if the forecast weather is hot, the application executing on the cloud control server 105 will add a predetermined power allowance for air conditioning operation along the route. In another example, if a strong headwind is forecast, an appropriate power allowance will be also added. In yet another example, if the trip is to take place at night, a power allowance for lighting of the vehicle will be taken into account. In yet another embodiment, the required power will be appropriately increased based on a sloping terrain along the route. As would be appreciate by persons of ordinary skill in the art, the above examples are exemplary only and many more factors may be sued in calculating the required charge to complete the trip. In another example, the expected speed of traffic is taken into account for required charge calculation. Similarly, road condition may also affect the amount of charge needed for the trip. For example, a snowy or wet road may require an additional electric charge due to the additional drag on the vehicle.

At step 206, after the required charge calculation is complete, the cloud control server 105 sends an EV charge initiation command through an application programming interface of the EVSE 100. The aforesaid command initiates the charging of the electric vehicle 104 based on the required amount of charge calculated in step 204.

Finally, at step 207, the calculated charge and other pertinent trip information are provided to the user's mobile device 109 and/or to the electric vehicle's onboard computer 106, where it is then displayed to the user using a graphical user interface. In one or more embodiments, the trip information is then used in vehicle's own navigation system for navigating the vehicle along the trip's route.

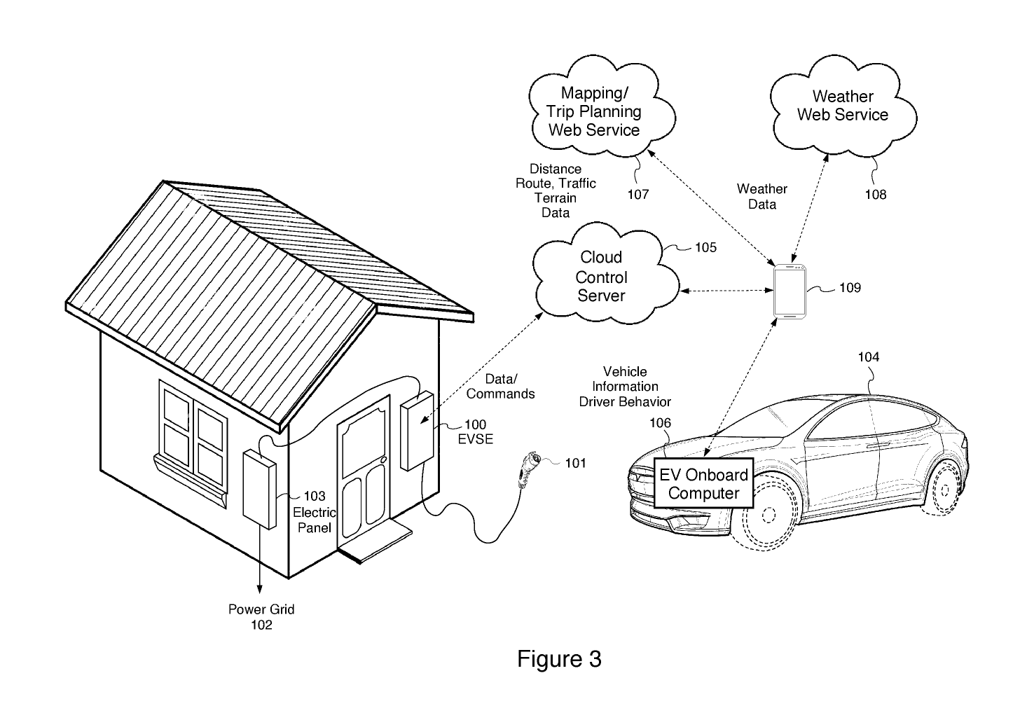

It should be noted that the above-described electric vehicle required charge calculation process may be similarly implemented not on the cloud control server 105, but on the user's smartphone 109, as shown in FIG. 3. In this embodiment, the application program residing on the smartphone 109 makes the above requests for various data and then sends the calculates required charge information to the cloud control server 105, which, in turn, issues the start charge command to the EVSE 100.

In one or more embodiments, if the required charge exceeds the vehicle's battery capacity, the inventive application may recalculate the travel route based on locations of available EV charging stations, where the user should to stop and re-charge the electric vehicle. The updated trip route is then sent to the vehicle for navigation. In one or more embodiments, the EV charging stations belong to other users and the corresponding charge transactions and associated fees are recorded on blockchain.

It should be further noted that in addition to the aforesaid trip planning, weather related and other described information, the software application executing on the cloud control server 105 may also take into account a multitude of other factors for scheduling the vehicle charging, including, without limitation, electric grid condition, such as power quality and grid load, local photovoltaic or other clean energy production, and the like. Exemplary implementations of electric vehicle charging installations, which take into account such grid conditions are described, for example, in U.S. patent application Ser. Nos. 15/690,275 and 15/004,974, incorporated herein by reference.

### Exemplary Computer Platform

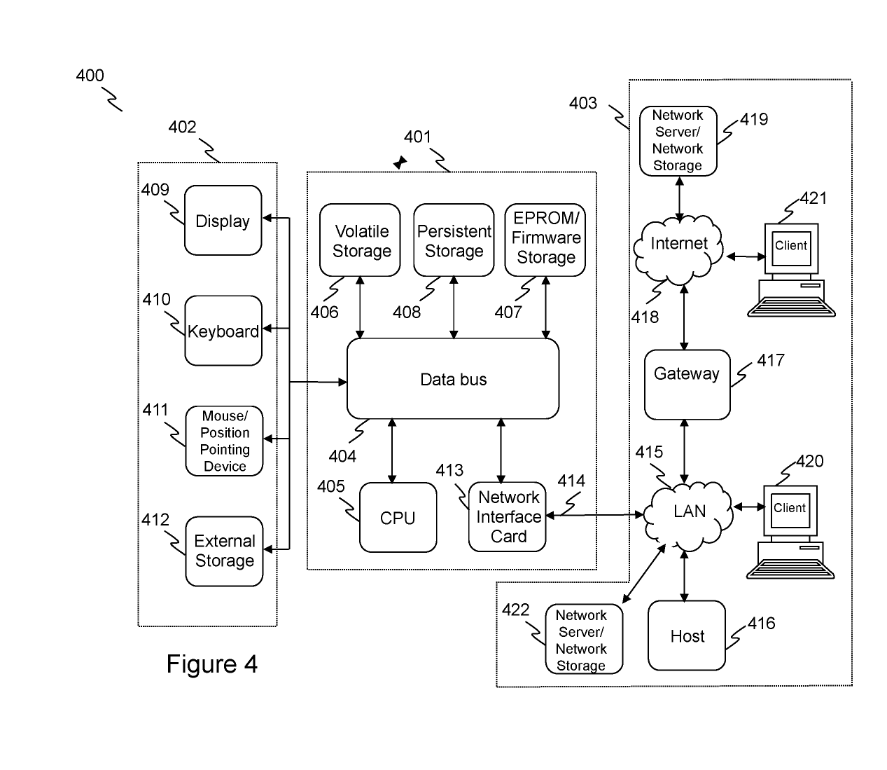

FIG. 4 is a block diagram that illustrates an embodiment of a computer/server system 400 upon which an embodiment of the inventive methodology may be implemented. The system 400 includes a computer/server platform 401, peripheral devices 402 and network resources 403. As would be appreciated by persons of ordinary skill in the art, various embodiments described hereinabove may be deployed based on the aforesaid computer/server system 400, which, in one embodiment, could be used as a building block for the cloud control server 105.

The computer platform 401 may include a data bus 405 or other communication mechanism for communicating information across and among various parts of the computer platform 401, and a processor 405 coupled with bus 401 for processing information and performing other computational and control tasks. Computer platform 401 also includes a volatile storage 406, such as a random access memory (RAM) or other dynamic storage device, coupled to bus 405 for storing various information as well as instructions to be executed by processor 405. The volatile storage 406 also may be used for storing temporary variables or other intermediate information during execution of instructions by processor 405. Computer platform 401 may further include a read only memory (ROM or EPROM) 407 or other static storage device coupled to bus 404 for storing static information and instructions for processor 405, such as basic input-output system (BIOS), as well as various system configuration parameters. A persistent storage device 408, such as a magnetic disk, optical disk, or solid-state flash memory device is provided and coupled to bus 401 for storing information and instructions.

Computer platform 401 may be coupled via bus 405 to a display 409, such as a cathode ray tube (CRT), plasma display, or a liquid crystal display (LCD), for displaying information to a system administrator or user of the computer platform 401. An input device 410, including alphanumeric and other keys, is coupled to bus 401 for communicating information and command selections to processor 405. Another type of user input device is cursor control device 411, such as a mouse, a trackball, or cursor direction keys for communicating direction information and command selections to processor 405 and for controlling cursor movement on display 409. This input device typically has two degrees of freedom in two axes, a first axis (e.g., x) and a second axis (e.g., y), that allows the device to specify positions in a plane.

An external storage device 412 may be coupled to the computer platform 401 via bus 405 to provide an extra or removable storage capacity for the computer platform 401. In an embodiment of the computer system 400, the external removable storage device 412 may be used to facilitate exchange of data with other computer systems.

The invention is related to the use of computer system 400 for implementing the techniques described herein. In an embodiment, the inventive system may reside on a machine such as computer platform 401. According to one embodiment of the invention, the techniques described herein are performed by computer system 400 in response to processor 405 executing one or more sequences of one or more instructions contained in the volatile memory 406. Such instructions may be read into volatile memory 406 from another computer-readable medium, such as persistent storage device 408. Execution of the sequences of instructions contained in the volatile memory 406 causes processor 405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 405 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 408. Volatile media includes dynamic memory, such as volatile storage 406.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 405 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 405. The bus 405 carries the data to the volatile storage 406, from which processor 405 retrieves and executes the instructions. The instructions received by the volatile memory 406 may optionally be stored on persistent storage device 408 either before or after execution by processor 405. The instructions may also be downloaded into the computer platform 401 via Internet using a variety of network data communication protocols well known in the art.

The computer platform 401 also includes a communication interface, such as network interface card 413 coupled to the data bus 405. Communication interface 413 provides a two-way data communication coupling to a network link 415 that is coupled to a local network 415. For example, communication interface 413 may be an integrated services digital network (ISDN) card or a modem to provide a data communication connection to a corresponding type of telephone line. As another example, communication interface 413 may be a local area network interface card (LAN NIC) to provide a data communication connection to a compatible LAN. Wireless links, such as well-known 802.11a, 802.11b, 802.11g and Bluetooth may also be used for network implementation. In any such implementation, communication interface 413 sends and receives electrical, electromagnetic or optical signals that carry digital data streams representing various types of information.

Network link 415 typically provides data communication through one or more networks to other network resources. For example, network link 415 may provide a connection through local network 415 to a host computer 416, or a network storage/server 417. Additionally or alternatively, the network link 413 may connect through gateway/firewall 417 to the wide-area or global network 418, such as an Internet. Thus, the computer platform 401 can access network resources located anywhere on the Internet 418, such as a remote network storage/server 419. On the other hand, the computer platform 401 may also be accessed by clients located anywhere on the local area network 415 and/or the Internet 418. The network clients 420 and 421 may themselves be implemented based on the computer platform similar to the platform 401.

Local network 415 and the Internet 418 both use electrical, electromagnetic or optical signals that carry digital data streams. The signals through the various networks and the signals on network link 415 and through communication interface 413, which carry the digital data to and from computer platform 401, are exemplary forms of carrier waves transporting the information.

Computer platform 401 can send messages and receive data, including program code, through the variety of network(s) including Internet 418 and LAN 415, network link 415 and communication interface 413. In the Internet example, when the system 401 acts as a network server, it might transmit a requested code or data for an application program running on client(s) 420 and/or 421 through Internet 418, gateway/firewall 417, local area network 415 and communication interface 413. Similarly, it may receive code from other network resources.

The received code may be executed by processor 405 as it is received, and/or stored in persistent or volatile storage devices 408 and 406, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive.

Moreover, other implementations of the invention will be apparent to those skilled in the art from consideration of the specification and practice of the invention disclosed herein. Various aspects and/or components of the described embodiments may be used singly or in any combination in systems and methods for electric vehicle charging with automated trip planning integration. It is intended that the specification and examples be considered as exemplary only, with a true scope and spirit of the invention being indicated by the following claims.

What is claimed is:

1. A system for electric vehicle charging with automated trip planning integration comprising:
a. an electric vehicle supply equipment for charging an electric vehicle battery from an electric power grid; and
b. a control server communicatively coupled with the electric vehicle supply equipment via a data network and executing a software application and configured to:
i. receive trip information from a user;
ii. obtain data associated with the trip information from a third party service;
iii. calculate a required charge level for the electric vehicle battery based on the received trip information and the obtained trip associated data; and
iv. issue a vehicle charge command to the electric vehicle supply equipment based on the calculated required electric vehicle battery charge level.

2. The system for electric vehicle charging with automated trip planning integration of claim 1, wherein the trip information comprises a trip destination.

3. The system for electric vehicle charging with automated trip planning integration of claim 1, wherein the trip information comprises a trip departure time.

4. The system for electric vehicle charging with automated trip planning integration of claim 1, wherein the trip information comprises information on at least one stop along the way.

5. The system for electric vehicle charging with automated trip planning integration of claim 1, wherein the obtained trip associated data comprises weather data.

6. The system for electric vehicle charging with automated trip planning integration of claim 5, wherein the weather data comprises temperature data.

7. The system for electric vehicle charging with automated trip planning integration of claim 5, wherein the weather data comprises wind data.

8. The system for electric vehicle charging with automated trip planning integration of claim 1, wherein the obtained trip associated data comprises traffic data.

9. The system for electric vehicle charging with automated trip planning integration of claim 8, wherein the traffic data comprises traffic speed data.

10. The system for electric vehicle charging with automated trip planning integration of claim 1, wherein the obtained trip associated data comprises day of the week data.

11. The system for electric vehicle charging with automated trip planning integration of claim 1, wherein the obtained trip associated data comprises vehicle data.

12. The system for electric vehicle charging with automated trip planning integration of claim 11, wherein the vehicle data comprises battery capacity data.

13. The system for electric vehicle charging with automated trip planning integration of claim 11, wherein the vehicle data comprises efficiency data.

14. The system for electric vehicle charging with automated trip planning integration of claim 11, wherein the vehicle data comprises aerodynamics data.

15. The system for electric vehicle charging with automated trip planning integration of claim 1, wherein the obtained trip associated data comprises driver data.

16. The system for electric vehicle charging with automated trip planning integration of claim 15, wherein the driver data comprises historical speed data.

17. The system for electric vehicle charging with automated trip planning integration of claim 15, wherein the driver data comprises historical braking data.

18. The system for electric vehicle charging with automated trip planning integration of claim 1, wherein the obtained trip associated data comprises distance data.

19. The system for electric vehicle charging with automated trip planning integration of claim 1, wherein the obtained trip associated data comprises route data.

20. The system for electric vehicle charging with automated trip planning integration of claim 1, wherein the obtained trip associated data comprises terrain data.

21. A non-transitory computer-readable medium embodying a set of computer-executable instructions, which, when executed in connection with a system for electric vehicle charging with automated trip planning integration comprising an electric vehicle supply equipment for charging an electric vehicle battery from an electric power grid and a control server communicatively coupled with the electric vehicle supply equipment via a data network and executing a software application, causes the system to:
i. receive trip information from a user;
ii. obtain data associated with the trip information from a third party service;
iii. calculate a required charge level for the electric vehicle battery based on the received trip information and the obtained trip associated data; and
iv. issue a vehicle charge command to the electric vehicle supply equipment based on the calculated required electric vehicle battery charge level.

22. A method performed in connection with a system for electric vehicle charging with automated trip planning integration comprising: an electric vehicle supply equipment for charging an electric vehicle battery from an electric power grid and a control server communicatively coupled with the electric vehicle supply equipment via a data network and executing a software application, the method comprising:
i. receiving trip information from a user;
ii. obtaining data associated with the trip information from a third party service;
iii. calculating a required charge level for the electric vehicle battery based on the received trip information and the obtained trip associated data; and
iv. issuing a vehicle charge command to the electric vehicle supply equipment based on the calculated required electric vehicle battery charge level.
